(19) United States
(12) Patent Application Publication
(10) Pub. No.: US 2010/0059138 A1
(43) Pub. Date: Mar. 11, 2010

(54) Method of Pressurizing a Gas Cylinder While Dispensing from Another

(75) Inventors: ZhiQiang Shi, He Bei (CN); David W. Pang, Beijing (CN)

Correspondence Address: BRACEWELL & GIULIANI LLP, P.O. BOX 61389, HOUSTON, TX, 77208-1389, US

(73) Assignee: NEOgas Inc., Spring, TX (US)

(21) Appl. No.: 12/557,296

(22) Filed: Sep. 10, 2009

Related U.S. Application Data
(60) Provisional application No. 61/095,682, filed on Sep. 10, 2008.

(51) Int. Cl. F17C 7/00; F17C 13/00

(52) U.S. Cl. 141/5; 141/95; 222/3; 222/395; 222/1

(57) ABSTRACT

A fixed and/or stationary modular unit consists of a hydraulic fluid tank and a pressurization pump. A compressed gas transportation system consists of a set of cylinders. Each cylinder has a charging port and a dispensing port. A valve is connected at the dispensing port of each cylinder. Each of the valves at the dispensing ports of the cylinders are connected to one another. After an idle period of dispensing activity, the valves on the dispensing ports of the cylinders are opened and compressed gas is bled from one of the cylinders into at least one of the other cylinders in the set until the at least one of the other cylinders reaches a desired dispensing pressure. Hydraulic fluid is pumped from the tank into the cylinder being bled from to maintain a substantially constant pressure within the cylinder.

This application claims priority to provisional application 61/095,682, filed Sep. 10, 2008.

### FIELD OF THE INVENTION

This invention is a method of boosting the pressure in a compressed gas cylinder while dispensing from another with hydraulic pressurization equipment in order to maintain a constant cylinder pressure throughout the gas dispensing operation.

### BACKGROUND OF THE INVENTION

Compressed natural gas (CNG) is any natural gas that has been processed and treated for transportation, in bottles or cylinders, at ambient temperature and at a pressure approaching the minimum compressibility factor.

Natural gas is colorless, odorless, and lighter than air, and it easily dissipates into the atmosphere when it leaks. It burns with a flame that is almost invisible, and it has to be raised to a temperature above 620° C. in order to ignite. By way of comparison, it should be noted that alcohol ignites at 200° C. and gasoline at 300° C. For safety reasons, natural gas is odorized with sulfur for marketing purposes.

Natural gas is an alternative to oil and therefore, it has great strategic importance, since it is a fossil fuel found in porous subsurface rock. It usually has low levels of pollutants, similar to nitrogen, carbon dioxide, water and sulfur compounds that remain in a gaseous state at atmospheric pressure and ambient temperature. Compressed natural gas is stored at a pressure of 220 bars or 3190 psi and is transported in trailers of varying volumetric capacity, depending on legislation and customer/project requirements.

The principal advantage of using natural gas is the preservation of the environment. In addition to economic benefits, it is a non-polluting fuel and it burns cleanly, so its combustion products that are released into the atmosphere do not need to be treated.

The great need to transport and store natural gas has contributed to increasing gas research around the world. Various methods have been proposed for storing and transporting compressed gases, such as natural gas, in pressurized vessels for overland transportation. The gas is typically stored and transported at high pressure and low temperature to maximize the amount of gas contained in each gas storage system. For example, compressed gas must be in a dense single-fluid state characterized as a very dense gas with no liquid.

CNG is typically transported over land in tanker trucks or tank wagons. Tankers have storage containers such as pressurized metal vessels. These storage vessels have high burst strengths and withstand the ambient temperature at which CNG is stored.

Storage vessels or cylinders are filled with compressed gas, typically using a compressor. A byproduct of the compression of the gas is heat, which ultimately raises the temperature of the gas in the cylinder. When a cylinder is filled to a specific pressure at a charging facility, for example 220 bar, that pressure will drop as the heat dissipates and the cylinder cools. When a series of cylinders reaches a dispensing location, the temperature of the cylinders has dropped, and as a result, the pressure of the cylinders has also dropped. Before gas can be dispensed from these cylinders, the gas pressure must be increased to the desired dispensing pressure, for example, 220 bar.

A new technique is necessary in order to ensure minimal delay in charging a cylinder to a desired dispensing pressure once it arrives at a dispensing location. The following technique may solve one or more of these problems. The present technique exceeds the deficiencies described by providing hydraulic pressurization equipment that is capable of servicing the motor vehicles efficiently while maintaining a substantially constant desired pressure at all times. A system is utilized to boost the pressure in a cylinder while dispensing from another.

### SUMMARY OF THE INVENTION

A fixed and/or stationary modular unit consists of a hydraulic fluid tank, a pressurization pump, and a compressed gas transportation system consisting of a set of cylinders. Each cylinder has two ports, a hydraulic fluid charging port and a gas dispensing port, with actuated valves positioned at each port. A valve is connected at the dispensing port of each cylinders with the valves at the dispensing ports of each cylinder also being connected to one another.

Gas is dispensed from the dispensing port of the cylinder by opening the valve at the dispensing port. The dispensing activity is monitored until a specified idle period has been met. The valves at the dispensing ports of at least two of the cylinders are opened and compressed gas is bled from one cylinder to another cylinder or plurality of cylinders. A pressure sensor monitors the pressure of the cylinder that compressed gas is being bled from and indicates when the pressure inside the cylinder has dropped. The valve connected to the incoming hydraulic fluid line is opened and hydraulic fluid is pumped from the tank into the cylinder to maintain a substantially constant desired pressure within the cylinder. Compressed gas is bled from one cylinder to another cylinder or plurality of cylinders until the other cylinder or plurality of cylinders have reached the desired dispensing pressure.

### BRIEF DESCRIPTION OF THE DRAWINGS

FIG. 1 is a schematic of a compressed gas filling system It illustrates the operation of the hydraulic pressurization equipment (HPU) connected to an over-the-road semi trailer.

FIG. 2 is a flow chart of the operating steps of the system for pressurizing a compressed gas cylinder while dispensing from another.

FIG. 3 is a schematic of an example of the system for pressurizing a compressed gas cylinder while dispensing from another.

### DETAILED DESCRIPTION OF THE INVENTION

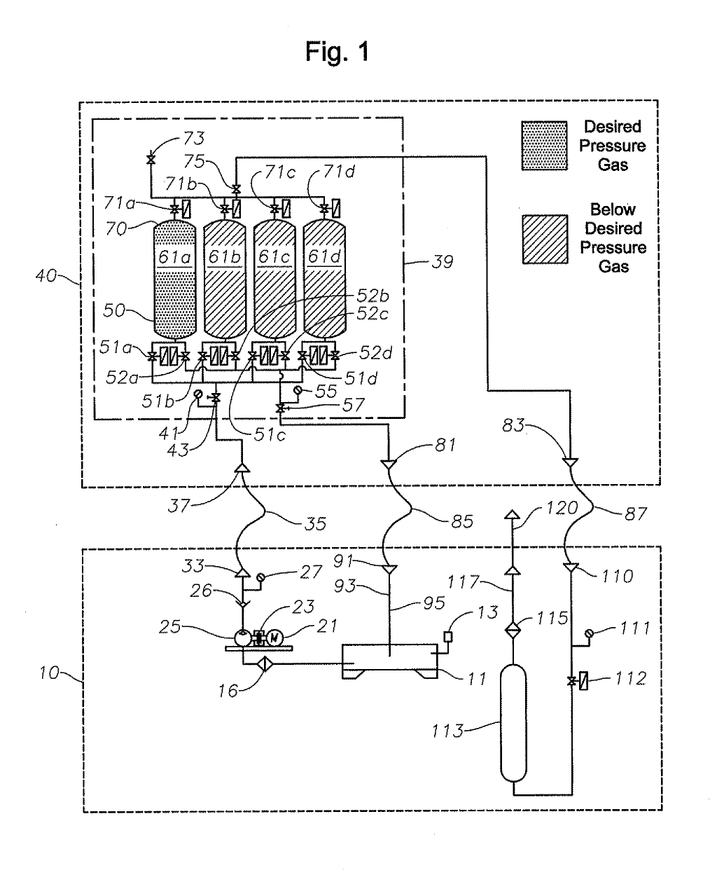

FIG. 1 illustrates a compressed gas dispensing system consisting of a hydraulic pressurization unit (HPU) 10, which is connected to an over-the-road compressed gas semi trailer 40.

As illustrated by FIG. 1, HPU 10 consists of a hydraulic fluid tank 11, a hydraulic level gauge 13, a particle filter 16, a motor 21, a coupling 23, a pump 25, a check valve 26, a pressure sensor 27, an outgoing fluid line 33, and a fluid return line 91. Additionally, HPU 10 consists of a capacity control sensor 93, a photoelectric control sensor 95, an incoming gas line 110, a pressure sensor 111, an actuated ball valve 112, a hydraulic fluid separator 113, a coalescing filter 115, and an outgoing gas dispensing line 117. An electric/electronic control panel (not visible), and programmable logic controller software complete HPU 10. HPU 10 ensures that the compressed gas cylinders are charged to a specific pressure throughout the dispensing operation. In order to accomplish this, HPU 10 pumps hydraulic oil into the cylinders as gas is dispensed, in order to maintain a specific pressure.

FIG. 1 also illustrates HPU 10 connected to an over-the-road compressed gas semi trailer 40 comprised of a gas cylinder module 39, of which each module may consist of grouped sets of horizontal (tubular) cylinders (for example 61a-d), each with the same volume capacity. Cylinders carry compressed gas such as compressed natural gas (CNG), hydrogen, and other gases. Each module has a charging end 50 and a dispensing end 70. Pressure gauges 41, 55, and a set of valves consisting of manual ball valves 43, 57, and actuated ball valves 51a-d, 52a-d are connected at the charging end 50 of module 39. The upstream connection from actuated ball valves 51a-d is connected to an incoming fluid line 37. The upstream connection from actuated ball valves 52a-d is connected to a fluid return line 81.

A set of valves consisting of actuated ball valves 71a-d, a manual ball valve 75, and a pressure relief valve 73 are connected at dispensing end 70 of cylinder module 39. The downstream connection from actuated ball valves 71a-d is connected to an outgoing gas line 83. The over-the-road semi trailer is charged with compressed gas at another location.

Cylinders are filled with compressed gas, typically using a compressor. A byproduct of the compression of the gas is heat, which ultimately raises the temperature of the gas in the cylinder. When a cylinder is filled to a specific pressure at a charging facility, for example 220 bar, that pressure will drop as the heat dissipates and the cylinder cools. When a series of cylinders reaches a dispensing location, the temperature of the cylinders has dropped, and as a result, the pressure of the cylinders has also dropped. Before gas can be dispensed from these cylinders, the gas pressure must be increased to the desired dispensing pressure, for example, 220 bar. In order to ensure minimal delay in charging a cylinder to a desired pressure once it arrives at a dispensing location, a system is utilized to boost the pressure in a cylinder while dispensing from another,

Once cylinder module 39 is filled with compressed gas, the gas is transported to a gas dispensing station where HPU 10 is installed. The over-the-road compressed gas semi trailer 40 is connected to HPU 10 with three hoses: an outgoing fluid hose 35, a return fluid hose 85, and a gas hose 87.

In order to dispense gas from cylinder module 39, the start button on the control panel (not visible) is pushed and HPU 10 begins unloading gas from the first cylinder 61a in compressed gas module 39 on over-the-road semi trailer 40. The electronic control panel (not visible) sends a signal to actuated ball valve 112 on HPU 10 and actuated ball valve 71a on dispensing end 70 of module 39, causing the valves to open, allowing the gas in cylinder 61a to be dispensed. The gas dispensed from module 39 flows through outgoing gas line 83 and gas hose 87 until it reaches gas line 110 of HPU 10. When the gas reaches line 110 of HPU 10, the gas flows through pressure sensor 111, actuated ball valve 112, hydraulic fluid separator 113, through coalescing filter 115, through dispensing line 117, and into gas line 120. As the gas is dispensed from cylinder 61a of module 39, pressure sensor 27, located downstream of check valve 26, senses the hydraulic pressure drop in cylinder 61a. When the pressure reaches a selected level, such as 210 bar or less, sensor 27 sends an electrical signal to the control panel (not visible). The control panel then sends a signal that simultaneously actuates motor 21 and opens actuated ball valve 51a on the charging end 50 of cylinder 61a.

Motor 21 suctions the hydraulic fluid from tank 11, forcing it through particle filter 16 to pump 25. Pump 25 forces the hydraulic fluid through check valve 26, outgoing fluid line 33, and outgoing fluid hose 35, until it reaches incoming fluid line 37 of the over-the-road semi trailer 40. The hydraulic fluid flows through actuated ball valve 51a and into cylinder 61a, forcing the gas from cylinder 61a out the dispensing end 70 of the module 39. Once pressure sensor 27 senses the gas pressure has reached a selected pressure, such as 220 bar or 3190 psi, an electronic signal from the control panel (not visible) switches off motor 21. Check valve 26 prevents hydraulic fluid from flowing back into tank 11.

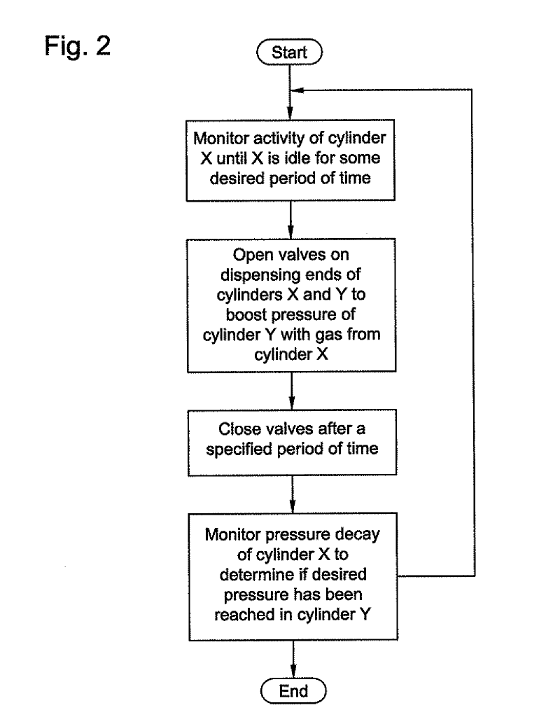

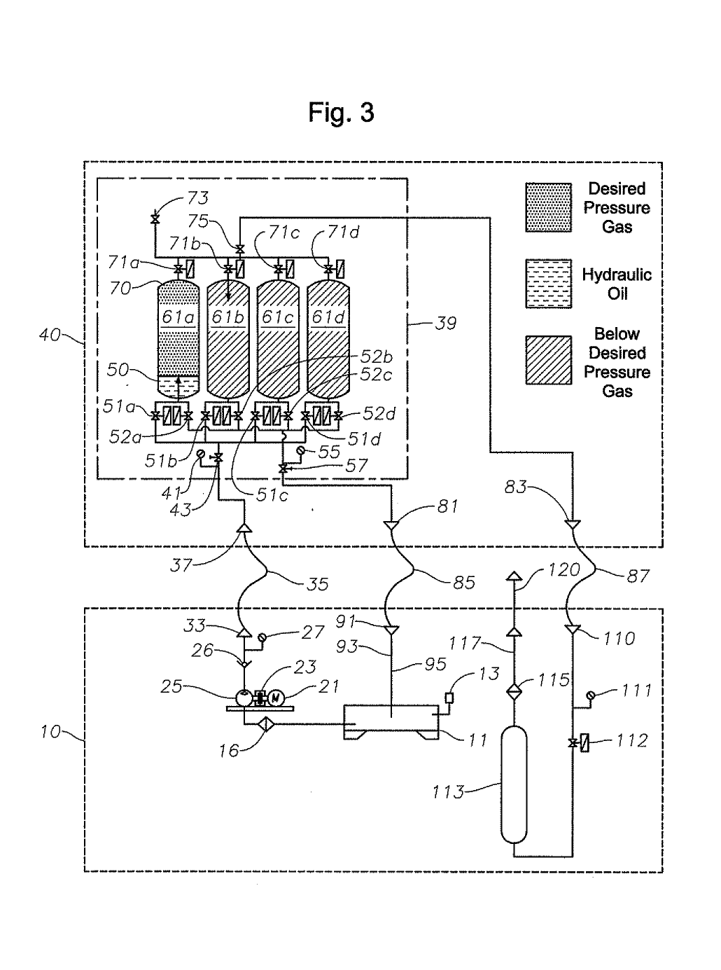

As gas is being dispensed from cylinder 61a, the pressure in cylinder 61b is below the desired dispensing pressure due to the temperature drop and subsequent pressure drop experienced during transport of the cylinders from the charging station to the dispensing location. In order to charge cylinder 61b to the desired dispensing pressure, cylinder 61b is charged using a method comprised by the invention, and as outlined in the flow chart of FIG. 2. The method requires bleeding gas from one cylinder into another. For example, referring to FIG. 3, cylinder 61a is being dispensed from, and cylinder 61b will follow once cylinder 61a is exhausted. In order to ensure that cylinder 61b is at the desired pressure by the time cylinder 61a is depleted, the pressure in cylinder 61b is boosted at intervals by gas from cylinder 61a. The boosting is controlled by the control panel (not visible). The control panel monitors the dispensing activity of module 39, and in particular cylinder 61a. When there has been a specified idle period in dispensing activity (i.e., actuated ball valve 112 is closed), the control panel sends a signal to actuated ball valves 71a, 71b, which had been closed and now open. The control panel monitors the flow of gas from cylinder 61a to cylinder 61b, and sends a signal to actuated ball valves 71a, 71b closing them after a specified amount of time. The amount of gas transferred from cylinder 61a to cylinder 61b is closely controlled and monitored by the control panel (not visible) to ensure that any pressure drop in cylinder 61a caused by the boosting of cylinder 61b is minimal.

When pressure sensor 27 senses a drop in pressure in cylinder 61a, it sends a signal to the control panel, which then functions as previously discussed, causing hydraulic oil to be pumped into cylinder 61a until it reaches a desired pressure. The boosting process continues in this cycle, until pressure sensor 27 does not sense a drop in pressure when charging cylinder 61b. If no pressure drop is detected, boosting is complete and cylinder 61b has been charged to the desired pressure. The boosting of cylinder 61b is done in small increments over an extended amount of time in order to minimize pressure drop in cylinder 61a, and subsequently, to reduce charging time for cylinder 61a. After cylinder 61b has been charged to the desired pressure, the boosting process continues by boosting the pressure in the next available cylinder, for example cylinder 61c.

When cylinder 61a is depleted, and gas is dispensed from cylinder 61b, the boosting process continues with gas from cylinder 61b boosting the remaining cylinders in the series that have not yet been boosted to the desired pressure. The process illustrated above continues until all of the cylinders in a series are boosted to a desired pressure.

The gas is dispensed and the dispensing process discussed above is repeated until cylinder 61a has been depleted. The hydraulic fluid is discharged from cylinder 61a as discussed in U.S. patent application Ser. No. 12/435,078, herein incorporated by reference.

When the discharge of hydraulic fluid from cylinder 61a begins, the control panel begins unloading gas from cylinder 61b (beginning another cycle). The cycle is repeated for each cylinder in a module until the entire module has been exhausted. The number of cylinders in a module, and the number of modules depends solely on the volume of gas that needs to be transported and the manufacturing standards of the over-the-road semi trailer.

The invention has significant advantages. The boosting system is a cost effective means of increasing the efficiency of the dispensing activity by minimizing delay times associated with charging a cylinder to a desired dispensing pressure. The boosting system allows for timely and efficient transition from one cylinder to another within a module.

While the invention has been shown in only a few of its forms, it should be apparent to those skilled in the art that it is not so limited but is susceptible to various changes without departing from the scope of the invention. For example, compressed gas may simultaneously be dispensed from more than one cylinder. Additionally, compressed gas may be bled from more than one cylinder simultaneously, and more than one cylinder may be boosted to a desired dispensing pressure simultaneously.

1. A method of pressurizing gas cylinders to a desired dispensing pressure, the method comprising:
(a) mounting first and second cylinders on a transport vehicle;
(b) filling the cylinders with compressed gas, thereby elevating the temperature within each cylinder;
(c) moving the transport vehicle to a compressed gas dispensing site, thereby allowing the cylinders to cool, resulting in the pressure of each cylinder dropping below a desired dispensing pressure;
(d) pumping hydraulic fluid into the first cylinder to thereby pressurize the cylinder to the desired dispensing pressure; and
(e) bleeding compressed gas from the first cylinder into the second cylinder until the pressure in the second cylinder reaches the desired dispensing pressure.

2. The method of claim 1, wherein the method further comprises after step (d), but before step (e):
dispensing compressed gas from the first cylinder; and
pumping hydraulic fluid into the first cylinder as the compressed gas is dispensed.

3. The method of claim 1, wherein the method further comprises after step (d), but before step (e):
monitoring the dispensing activity of the first cylinder until a desired idle period has passed.

4. The method of claim 3, wherein step (e) further comprises:
monitoring pressure in the first cylinder; and
pumping hydraulic fluid into the first cylinder to thereby pressurize the first cylinder to the desired dispensing pressure when the pressure drops a specified amount below the desired pressure.

5. The method of claim 1, wherein step (b) comprises filling the cylinders to a pressure greater than or equal to the desired dispensing pressure.

6. The method of claim 2, further comprising:
when the first cylinder is depleted of compressed gas to a selected minimum amount, dispensing compressed gas from the second cylinder; and
pumping hydraulic fluid into the second cylinder as the compressed gas is dispensed.

7. The method of claim 1, wherein step (d) comprises pumping hydraulic fluid only into the first cylinder and not into the second cylinder as long as the first cylinder contains an amount of compressed gas above a selected minimum.

8. A method of pressurizing gas cylinders to a desired dispensing pressure, the method comprising:
(a) mounting first and second cylinder on a transport vehicle;
(b) filling the cylinders with compressed gas to a pressure greater than or equal to a desired dispensing pressure, thereby elevating the temperature within each cylinder;
(c) moving the transport vehicle to a compressed gas dispensing site, thereby allowing the cylinders to cool, resulting in the pressure of each cylinder dropping below the desired dispensing pressure;
(d) providing a compressed gas dispensing system with a pump;
(e) connecting the cylinders to the compressed gas dispensing system;
(f) pumping hydraulic fluid with the pump into the first cylinder but not the second cylinder to thereby pressurize the first cylinder to the desired dispensing pressure; and
(g) bleeding compressed gas from the first cylinder into the second cylinder until the pressure in the second cylinder reaches the desired dispensing pressure.

9. The method of claim 8, wherein the method further comprises after step (f), but before step (g):
dispensing compressed gas to a motor vehicle from the first cylinder; and
pumping hydraulic fluid into the first cylinder as the compressed gas is dispensed.

10. The method of claim 8, wherein the method further comprises after step (f), but before step (g):
monitoring the dispensing activity of the first cylinder until a desired idle period has passed.

11. The method of claim 9, wherein step (g) further comprises:
monitoring pressure in the first cylinder; and
pumping hydraulic fluid into the first cylinder when the pressure within the first cylinder drops a specified amount below the desired pressure as the compressed gas is bled.

12. The method of claim 9, further comprising:
when the first cylinder is depleted of compressed gas to a selected minimum amount, dispensing compressed gas from the second cylinder to a motor vehicle; and
pumping hydraulic fluid into the second cylinder as the compressed gas is dispensed.

13. The method of claim 8, wherein step (f) comprises pumping hydraulic fluid only into the first cylinder and not into the second cylinder as long as the first cylinder contains an amount of compressed gas above a selected minimum.

14. A method of pressurizing gas cylinders to a desired dispensing pressure, the method comprising:
(a) mounting first and second cylinders on a transport vehicle;
(b) filling the cylinders with compressed gas, thereby elevating the temperature within each cylinder;
(c) moving the transport vehicle to a compressed gas dispensing site, thereby allowing the cylinders to cool, resulting in the pressure of each cylinder dropping below a desired dispensing pressure;
(d) pumping hydraulic fluid into the first cylinder to thereby pressurize the cylinder to the desired dispensing pressure;
(e) dispensing compressed gas from the first cylinder into a motor vehicle;
(f) monitoring the pressure in the first cylinder, and pumping hydraulic fluid into the first cylinder as the compressed gas is dispensed to thereby pressurize the first cylinder to the desired dispensing pressure when the pressure drops a specified amount below the desired pressure;
(g) monitoring the dispensing activity of the first cylinder until a desired idle period has passed;
(h) bleeding compressed gas from the first cylinder into the second cylinder until the pressure in the second cylinder reaches the desired dispensing pressure; and
(i) when the first cylinder is depleted of compressed gas to a selected minimum amount, dispensing compressed gas from the second cylinder to a motor vehicle, and pumping hydraulic fluid into the second cylinder as the compressed gas is dispensed.

15. The method of claim 14, wherein step (f) comprises pumping hydraulic fluid only into the first cylinder and not into the second cylinder as long as the first cylinder contains an amount of compressed gas above a selected minimum.

16. The method of claim 14, wherein step (b) comprises filling the cylinders to a pressure greater than or equal to the desired dispensing pressure.
